(19) United States
(12) Patent Application Publication
(10) Pub. No.: US 2025/0242671 A1
(43) Pub. Date: Jul. 31, 2025

(54) VEHICULAR DOOR

(71) Applicant: TOYOTA BOSHOKU KABUSHIKI KAISHA, Aichi-ken (JP)

(72) Inventors: Masanori ISHIZUKA, Aichi-ken (JP); Goro TAKAHASHI, Aichi-ken (JP); Mitsutaka SAKO, Aichi-ken (JP); Yasuyuki SHIMIZU, Aichi-ken (JP); Kazuma UCHIBORI, Aichi-ken (JP)

(73) Assignee: TOYOTA BOSHOKU KABUSHIKI KAISHA, Aichi-ken (JP)

(21) Appl. No.: 19/013,681

(22) Filed: Jan. 8, 2025

(30) Foreign Application Priority Data
Jan. 30, 2024 (JP) 2024-011420

(51) Int. Cl. B60J 5/04

(52) U.S. Cl. CPC B60J 5/0413; B60J 5/0415; B60J 5/0483

(57) ABSTRACT

A vehicular door includes an outer panel having an external side surface that is configured as an outer wall surface of a vehicle and an inner panel disposed on a vehicular interior side with respect to the outer panel and having an interior side surface that faces a compartment space of the vehicle. The inner panel includes at least a first panel member and a second panel member. Each of the first panel member and the second panel member includes a non-overlapping portion that has the interior side surface facing the compartment space and an exterior side surface directly facing the outer panel without having any panels between the non-overlapping portion and the outer panel.

### CROSS REFERENCE TO RELATED APPLICATION

This application claims priority from Japanese Patent Application No. 2024-11420 filed on Jan. 30, 2024. The entire contents of the priority application are incorporated herein by reference.

### TECHNICAL FIELD

The present technology described herein relates to a vehicular door.

### BACKGROUND

There has been known a vehicular door that includes a door panel and a resin trim. The door panel includes a metal outer panel, which is configured as a door outer surface, and an inner panel. The resin trim is configured as a door inner surface. There has been also known another configuration in which various kinds of functional components are mounted on an inner panel made of synthetic resin and the inner panel with the various kinds of functional components is fitted to the outer panel. With such a configuration, the number of mounting steps and a production cost may be reduced.

### SUMMARY

In the above configuration, the mount member for mounting the metal door panel to a vehicle body member needs to have high rigidity. Therefore, the mount member needs to have a great thickness and may be fixed to the plate surface of the metal door panel with welding. The vehicular door generally has a configuration including three plate members that are overlapped with respect to a vehicular interior-exterior direction. With the above configuration, the number of components for the vehicular door is increased and therefore, the production steps and a production cost are also increased.

An object of the present technology described herein is to provide a vehicular door with a low production cost. Further, a vehicular door that is produced with a simplified production process is provided.

A vehicular door according to the technology described herein includes an outer panel having an external side surface that is configured as an outer wall surface of a vehicle and an inner panel disposed on a vehicular interior side with respect to the outer panel and having an interior side surface that faces a compartment space of the vehicle. The inner panel includes at least a first panel member and a second panel member. Each of the first panel member and the second panel member includes a non-overlapping portion that has the interior side surface facing the compartment space and an exterior side surface directly facing the outer panel without having any panels between the non-overlapping portion and the outer panel.

### BRIEF DESCRIPTION OF THE DRAWINGS

FIG. 1 is a perspective view illustrating a side door seen from a vehicular interior side.

FIG. 2 is a cross-sectional view of the side door seen from a vehicular rear side.

FIG. 3 is an exploded perspective view illustrating the side door.

FIG. 4 is a cross-sectional view of a portion of the side door including a hinge mechanism.

FIG. 5 is a cross-sectional view of another portion of the side door including the hinge mechanism.

### DETAILED DESCRIPTION

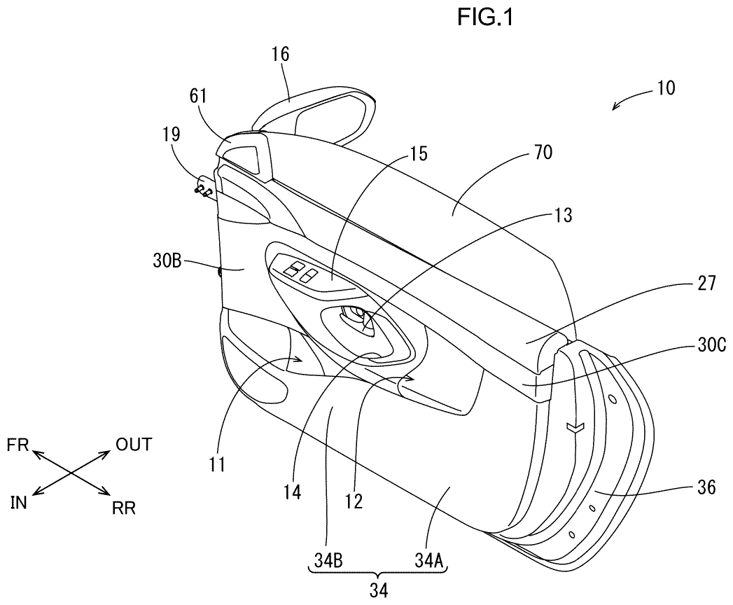

A side door 10 will be described as one example of a vehicular door with reference to FIGS. 1 to 5. The side door 10 of this embodiment is a front side door of an automobile. In each drawing, the arrows FR and RR represent a vehicular front side and a vehicular rear side, respectively, and the arrows IN and OUT represent a vehicular interior side and a vehicular exterior side, respectively.

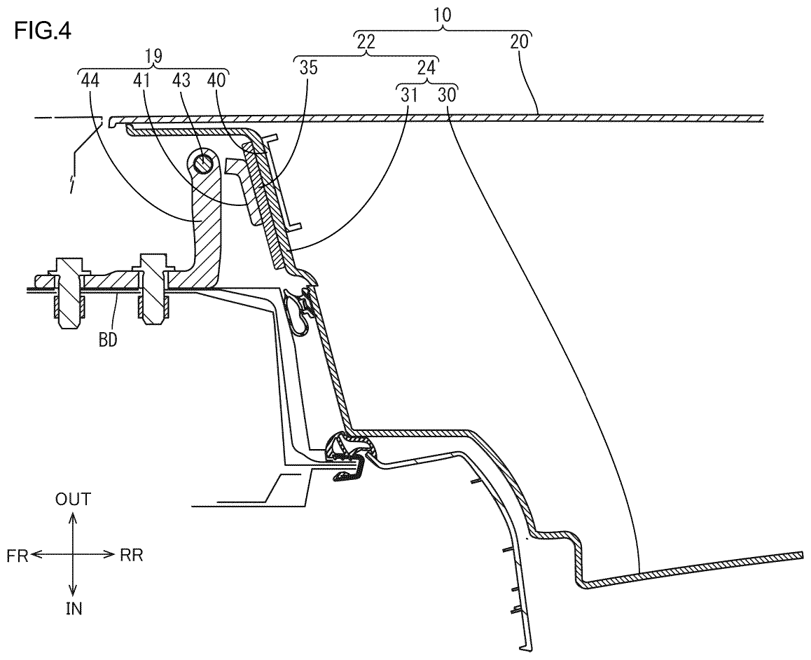

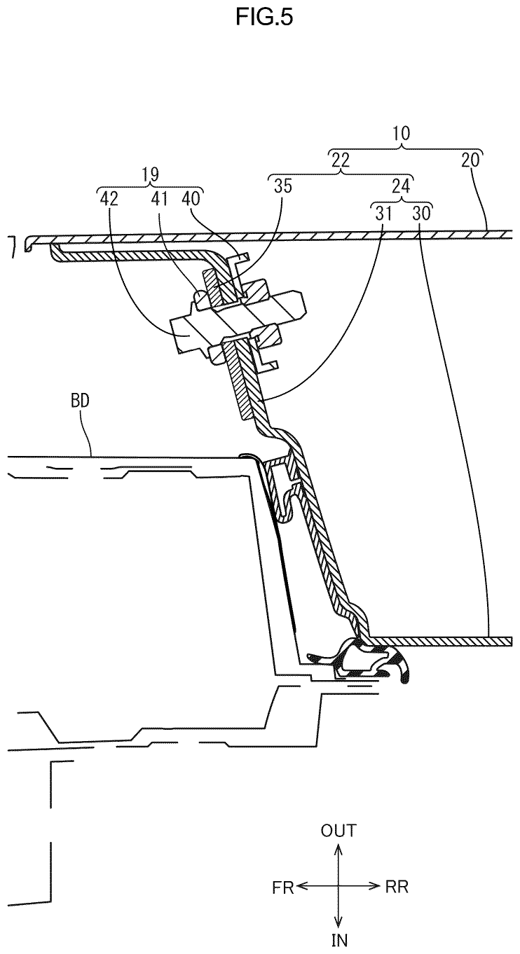

As illustrated in FIG. 1, on a vehicular interior side surface, the side door 10 of this embodiment includes a door pocket 11, an armrest 12 on which a passenger's arm is placed, an inside handle 13 for opening and closing the side door 10, a pull handle 14 that is held by the passenger to open or close the side door 10, and a switch base 15 that includes operation switches for opening and closing a window and locking and unlocking the side door 10. On a vehicular exterior side surface, the side door 10 includes a side mirror 16. Furthermore, the side door 10 includes a window assembly 17 and a locking unit 18 for locking and unlocking the side door 10 with respect to a vehicle body. As illustrated in FIGS. 4 and 5, the side door 10 of this embodiment is fixed to a vehicle body BD at a front portion thereof via a hinge mechanism 19. Accordingly, the side door 10 is moved around the hinge mechanism 19 to be opened and closed.

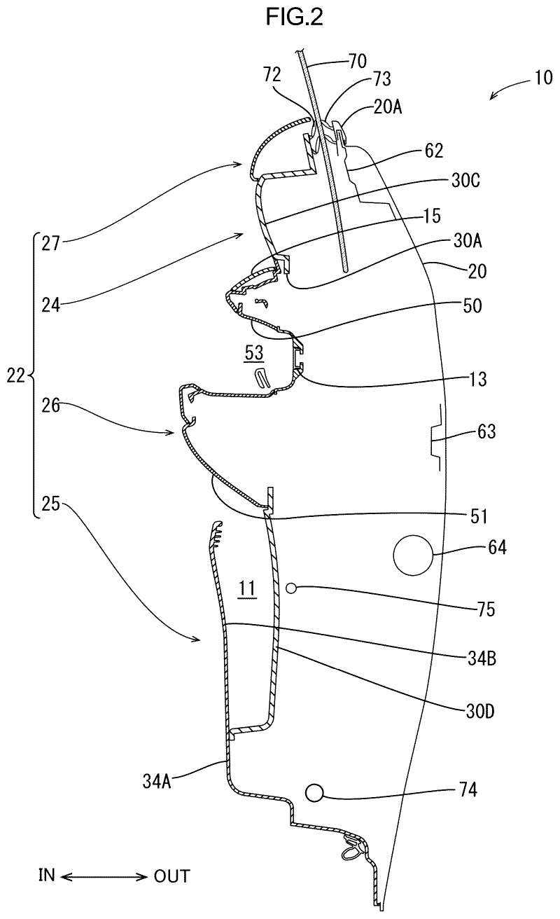

As illustrated in FIG. 2, the side door 10 includes two panels that are an outer panel 20 and an inner panel 22. The outer panel 20 and the inner panel 22 are joined together and configured as the side door 10. The outer panel 20 is an outermost panel of a vehicle that is configured as an exterior appearance of the vehicle. The outer panel 20 is a steel plate panel. The inner panel 22 is a panel that is configured as an interior member or an interior appearance of the vehicle (an interior design surface). As illustrated in FIG. 2, no panels are disposed between the outer panel 20 and the inner panel 22. The outer panel 20 and the inner panel 22 are directly opposite each other and configured as the side door 10.

The outer panel 20 is a steel plate in this embodiment; however, the outer panel 20 may be made of other metal or may be made of resin. Examples of resin used for the outer panel 20 include fiber reinforced plastics (obtained by reinforcing thermosetting resin such as non-saturated polyester, epoxy resin, polyamide resin, phenol resin with glass fibers, carbon fibers, aramid fibers, polyethylene fibers), polyacetal resin, polyamide resin, polycarbonate resin, polyimide resin, and ultrahigh molecular weight polyolefin (polyethylene) resin. Most of the components of the side door 10 are mounted on the inner panel 22 and few components are included in the outer panel 20.

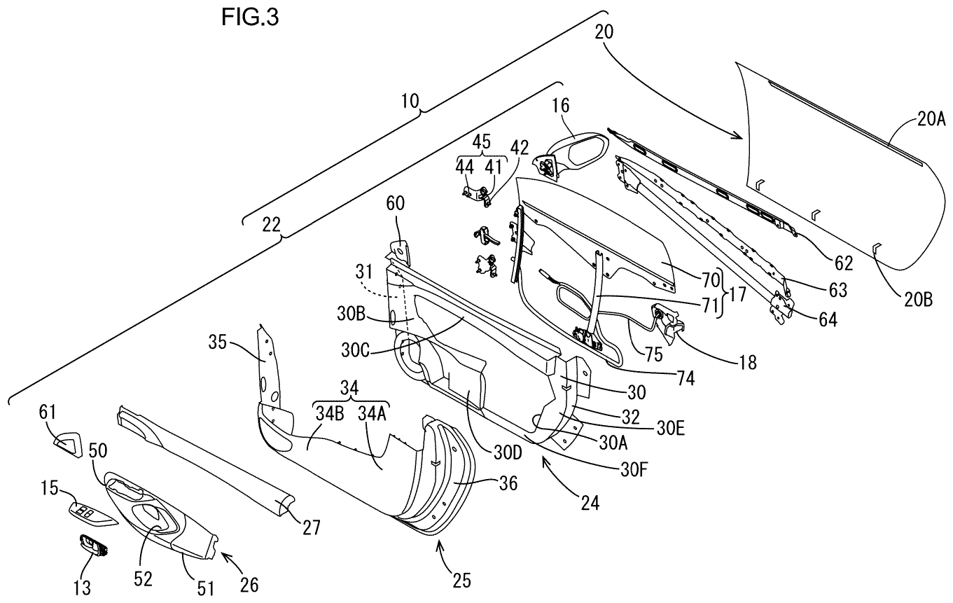

As illustrated in FIG. 3, the inner panel 22 includes four panel members including a first panel member 24, a second panel member 25, a third panel member 26, and a fourth panel member 27. The first panel member 24 has a frame shape including an outer peripheral portion of the inner panel 22. The first panel member 24 is configured as a base member on which the second panel member 25, the third panel member 26, the fourth panel member 27, and various kinds of functional components are mounted. In this embodiment, the second panel member 25, the third panel member 26, the fourth panel member 27 are made of resin and the first panel member 24 is made of aluminum alloy and made with aluminum diecasting. The first panel member 24 may be made of resin. Examples of resin used for the inner panel 22 include polypropylene resin, polyethylene resin, polystyrene resin, polyester resin, and each of the resins including natural fibers.

As illustrated in FIG. 3, the first panel member 24 includes a first panel body portion 30, a first front wall portion 31, and a rear wall portion 32. The first panel body portion 30 has plate surfaces that face a vehicular interior side and a vehicular exterior side, respectively. The first front wall portion 31 projects and extends from a front edge of the vehicular exterior side surface of the first panel body portion 30 toward the vehicular exterior side. The rear wall portion 32 projects and extends from a rear edge of the first panel body portion 30 toward the vehicular exterior side. The first panel body portion 30 has a hole 30A in a middle section and has a rectangular frame shape around the hole 30A. As illustrated in FIGS. 1 and 2, the first panel body portion 30 includes a front upper portion 30B and an upper edge portion 30C that are face the vehicular interior side. The front upper portion 30B and the upper edge portion 30C are exposed and face a compartment space of the vehicle and are configured as the interior design surface. Any other panel members are not disposed to overlap the front upper portion 30B and the upper edge portion 30C on the vehicular exterior side. The front upper portion 30B and the upper edge portion 30C are disposed directly opposite the outer panel 20 without having any other panel members therebetween (refer to FIG. 2). The front upper portion 30B and the upper edge portion 30C are configured as non-overlapping portions of the first panel member 24. The front upper portion 30B and the upper edge portion 30C have vehicular interior side surfaces facing the compartment space and vehicular exterior side surfaces directly facing the outer panel 20 without having any other panel members therebetween.

The second panel member 25 is disposed on the vehicular interior side with respect to the first panel member 24. The second panel member 25 covers a lower portion of the first panel member 24. More in detail, the second panel member 25 includes a second panel body portion 34, a second front wall portion 35, and an extending portion 36. The second panel body portion 34 has plate surfaces that face the vehicular interior side and the vehicular exterior side, respectively. The second front wall portion 35 projects and extends from a front edge of the vehicular exterior side surface of the second panel body portion 34 toward the vehicular exterior side. The extending portion 36 extends outward from a lower edge and a rear edge of the second panel body portion 34. The second panel body portion 34 includes a rear portion 34A and a front portion 34B. The rear portion 34A covers a rear portion 30E and a lower portion 30F of the first panel body portion 30. As illustrated in FIG. 2, the rear portion 34A is directly opposite the outer panel 20 without having any panel members therebetween. Any other panel members are not disposed to overlap the rear portion 34A on the vehicular exterior side. The rear portion 34A is configured as the non-overlapping portion of the second panel member 25. The rear portion 34A has a vehicular interior side surface facing the compartment space and a vehicular exterior side surface directly facing the outer panel without having any panel members therebetween. The rear portion 34A is opposite the outer panel 20 through the hole 30A of the first panel body portion 30.

As illustrated in FIG. 2, with the second panel member 25 and the first panel member 24 being joined together, the front portion 34B of the second panel body portion 34 is opposite and away from a front lower portion 30D of the first panel body portion 30. The front portion 34B is disposed on the vehicular interior side of the front lower portion 30D. A door pocket 11 that is open upward is defined by the front portion 34B of the second panel body portion 34 and the front lower portion 30D of the first panel body portion 30. The door pocket 11 has a space that is defined between the front portion 34B and the front lower portion 30D.

The second front wall portion 35 of the second panel member 25 extends upward from a lower edge of the second panel body portion 34. As illustrated in FIGS. 4 and 5, the second front wall portion 35 and the first front wall portion 31 of the first panel member 24 overlap so as to be contacted with each other. The first front wall portion 31 and the second front wall portion 35 are fixed to the vehicle body BD via the hinge mechanism 19. Thus, the first panel member 24 and the second panel member 25 are fixed to the vehicle body BD. Since forces are concentrated on the hinge mechanism 19 when the door is opened and closed, the hinge mechanism 19 needs to be fixed to the first panel member 24 and the second panel member 25 with high strength. In this respect, according to this embodiment, the first front wall portion 31 of the first panel member 24 and the second front wall portion 35 of the second panel member 25 of the inner panel 22 are fixed together with the hinge mechanism 19 with high strength. The hinge mechanism 19 includes a hinge plate 40, a hinge bracket 45 including a first hinge bracket portion 41 and a second hinge bracket portion 44, a screw 42, and a rotary shaft 43. The hinge bracket 45 includes the second hinge bracket portion 44 and the first hinge bracket portion 41 that extends from the second hinge bracket portion 44.

Specifically, as illustrated in FIG. 5, the first front wall portion 31 of the first panel member 24 and the second front wall portion 35 of the second panel member 25 are overlapped with each other and are fixed together with the screw 42 with the hinge plate 40 supporting the overlapped wall portions 31, 35 from the vehicular exterior side and the first hinge bracket portion 41 being sandwiched between the overlapped wall portions 31, 35 and a screw head of the screw 42 from the vehicular interior side. Namely, as illustrated in FIG. 5, the hinge plate 40, the first front wall portion 31, the second front wall portion 35, and the hinge bracket 45 are joined together with the screw 42. As illustrated in FIG. 4, the rotary shaft 43 is fitted in the second hinge bracket portion 44. The second hinge bracket portion 44 of the hinge bracket 45 is fixed to the vehicle body BD and the first hinge bracket portion 41 of the hinge bracket 45 is fixed to the first panel member 24 and the second panel member 25. Thus, the first panel member 24 and the second panel member 25 are fixed to the vehicle body BD via the hinge mechanism 19. With such a configuration, the side door 10 is movable around the rotary shaft 43 to be opened and closed. Thus, only the inner panel 22 is fixed to the vehicle body BD via the hinge mechanism 19.

As previously described, the first panel member 24 is formed with aluminum diecasting and is a unitary component made of aluminum alloy. Therefore, the first panel member 24 has higher rigidity than a panel member made of resin. Furthermore, with the first panel member 24 being formed with aluminum diecasting, the thickness of the first panel member 24 can be easily varied in different portions and the rigidity can be easily varied in different portions. Therefore, with the first front wall portion 31 being formed to be thicker than the first panel body portion 30, rigidity of the first front wall portion 31 is increased. With respect to the second panel member 25 that is made of resin, with the second front wall portion 35 being formed to be thicker than the second panel body portion 34, rigidity of the second front wall portion 35 is increased.

The second panel member 25 and the first panel member 24 are joined together with the extending portion 36 of the second panel member 25 overlapping the rear wall portion 32 of the first panel member 24 and covering an entire surface of the rear wall portion 32. With the side door 10 being opened, the extending portion 36 that is configured as a rear end portion of the side door 10 is uncovered and can be seen by a passenger With the extending portion 36, which can be seen by a passenger when the door is opened, being processed with emboss processing, the design of the surface of the extending portion 36 is improved.

The locking unit 18 is disposed in front of the rear wall portion 32 of the first panel member 24 and on the vehicular exterior side of the rear portion 30E of the first panel body portion 30. The side door 10 is locked with respect to the vehicle body BD with the locking unit 18 that is disposed near the rear wall portion 32. Therefore, rigidity of the rear wall portion 32 of the first panel member 24 also needs to be increased. Similar to the first front wall portion 31, with the rear wall portion 32 being formed thicker than the first panel body portion 30, the rigidity of the rear wall portion 32 is increased.

As illustrated in FIGS. 2 and 3, the third panel member 26 has a shape protruding toward the vehicular interior side. With such a configuration, the armrest 12 and the pull handle 14 are formed and mounting portions for receiving the inside handle 13 and the switch base 15 are formed. Specifically, as illustrated in FIG. 2, the third panel member 26 includes a first protruding portion 50 and a second protruding portion 51 that protrude toward the compartment space. The first protruding portion 50 is on a relatively upper side than the second protruding portion 51. The first protruding portion 50 is a front section of the third panel member 26 with respect to the front-rear direction. The first protruding portion 50 has an upper surface that horizontally extends and on which the switch base 15 is mounted. The second protruding portion 51 is on a relatively lower side than the first protruding portion 50. The second protruding portion 51 is a rear section of the third panel member 26 with respect to the front-rear direction. The second protruding portion 51 has an upper surface that is configured as the armrest 12 and includes a recessed portion 52 in the upper surface in front of the armrest 12. The recessed portion 52 is configured as the pull handle 14. A portion of the third panel member 26 between the first protruding portion 50 and the second protruding portion 51 with respect to the upper-bottom direction is configured as a recessed portion 53 that is recessed toward the vehicular exterior side since the first protruding portion 50 and the second protruding portion 51 protrude toward the vehicular interior side. The inside handle 13 is in the recessed portion 53.

The third panel member 26 is mounted on the first panel member 24 to cover a front area of the hole 30A that is not covered by the second panel member 25. An almost entire area of the vehicular interior side surface of the third panel member 26 is configured as the vehicular interior design surface that faces the compartment space. Furthermore, the third panel member 26 is disposed directly opposite the outer panel 20 without having any other panel members therebetween. The third panel member 26 as a whole is configured as the non-overlapping portion.

The fourth panel member 27 is an elongated member extending in the front-rear direction and covers an upper edge of the first panel member 24. The first panel member 24 includes an upper protruding portion 60 that protrudes upward from a front edge portion thereof. The upper protruding portion 60 protrudes upper than the fourth panel member 27. The upper protruding portion 60 is a mounting base where the side mirror 16 is mounted. The side mirror 16 is fixed to the upper protruding portion 60 with fixing members so as to protrude toward the vehicular exterior side. A cover member 61 for covering the fixing members is attached to the vehicular interior side surface of the upper protruding portion 60. Thus, the side mirror 16 is attached to the inner panel 22.

As illustrated in FIGS. 2 and 3, the inner panel 22 includes a first reinforcing member 62, a second reinforcing member 63, and a third reinforcing member 64 on the vehicular exterior side thereof. The first reinforcing member 62, the second reinforcing member 63, and the third reinforcing member 64 have an elongated shape extending in the front-rear direction. More in detail, the first reinforcing member 62, the second reinforcing member 63, and the third reinforcing member 64 are disposed on the vehicular exterior side of the first panel member 24 and extend from the first front wall portion 31 to the rear wall portion 32 of the first panel member 24. Front edge portions of the first reinforcing member 62, the second reinforcing member 63, and the third reinforcing member 64 are fixed to the first front wall portion 31 and rear edge portions of the first reinforcing member 62, the second reinforcing member 63, and the third reinforcing member 64 are fixed to the rear wall portion 32. The first reinforcing member 62 extends along an upper edge of the first panel body portion 30. The second reinforcing member 63 is disposed below the first reinforcing member 62 and extends along a middle section of an inner surface of the outer panel 20 with respect to the upper-bottom direction. The middle section of the outer panel 20 corresponds to an outermost portion of the outer panel 20. The third reinforcing member 64 is configured as an impact beam for reducing shock from the outside of the vehicle in case of side collision. The third reinforcing member 64 is disposed at a level of a hip of a passenger who is seated.

The outer panel 20 is detachably mounted on the inner panel 22 and covers the inner panel 22 from the vehicular exterior side. Specifically, as illustrated in FIGS. 2 and 3, the outer panel 20 includes a folded portion 20A on au upper edge and fitting projections 20B on a lower edge portion of a back side surface (the interior side surface) thereof. The folded portion 20A is folded on the back surface side (the vehicular interior side) and the fitting projections 20B project from the interior side surface of the outer panel 20. The fitting projections 20B are fitted in through holes formed in the inner panel 22. Specifically, the fitting projections 20B are fitted in the through holes formed in a lower edge section of the extending portion 36 of the second panel member 25. With the folded portion 20A being hooked on the first reinforcing member 62, the fitting projections 20B are fitted in the through holes of the second panel member 25 and accordingly, the outer panel 20 is attached to the inner panel 22.

A window assembly 17 is disposed on the vehicular exterior side of the inner panel 22 and on the vehicular interior side of the first reinforcing member 62, the second reinforcing member 63, and the third reinforcing member 64. The window assembly 17 includes a window glass 70 of a plate shape and a regulator 71 that is a driving source for moving up and down the window glass 70. As illustrated in FIG. 2, a weatherstrip 72 is attached to the exterior side surface of an upper edge of the first panel member 24 to seal a gap between the window glass 70 and the first panel member 24 and allow the window glass 70 to move up and down. A weatherstrip 73 is attached to the interior side surface of the folded portion 20A on the upper edge of the outer panel 20 to seal a gap between the window glass 70 and the outer panel 20 and allow the window glass 70 to move up and down. The window glass 70 is movably disposed between the weatherstrips 72, 73 that are opposite each other.

A wire 74 that connects the regulator 71 and the switch base 15 and a wire 75 that connects the locking unit 18 and the inside handle 13 are supported by the inner panel 22. With such a configuration, the wires 74, 75 need not be detached from the inner panel 22 when the outer panel 20 is separated from the inner panel 22. Only the weatherstrip 73, which is on the vehicular exterior side, is mounted on the outer panel 20, when the outer panel 20 is separated from the inner panel 22.

As previously described, the side door 10 of this embodiment includes the inner panel 22 that includes multiple panel members. The panel members include the first panel member 24, the second panel member 25, and the third panel member 26. Each of the first panel member 24, the second panel member 25, and the third panel member 26 includes the non-overlapping portion that is configured as the vehicular interior design surface and is directly opposite the outer panel 20 without having any other panel members between each of the first, second, and third panels 24, 25, 26 and the outer panel 20. The non-overlapping portion has a double structure of the outer panel 20 and the inner panel 22 that are directly opposite each other without having any panel members therebetween. The side door 10 of this embodiment includes multiple portions that are configured as the vehicular interior design surfaces and have the double structure. Therefore, the number of components of the side door 10 is relatively small.

As illustrated in FIG. 2, the side door 10 includes no plate member between the outer panel 20 and the inner panel 22 and has a large inner space between the outer panel 20 and the inner panel 22. Therefore, functional components can be mounted with various arrangements. With the side door 10 of this embodiment, the production process is simplified and becomes easy and a production cost is reduced.

A generally known vehicular door panel includes a door panel made of metal and a door trim made of resin. The door panel includes an exterior side panel and an interior side panel that are made of metal. The resin door trim is mounted on the metal door panel on a vehicular interior side. Namely, the generally known vehicular door has a three-plates structure in which three plate members are overlapped in a vehicular interior-exterior direction. The vehicular door described herein includes multiple portions that are configured as vehicular interior design surfaces and have a double structure in which the outer panel 20 and the inner panel 22 are overlapped. Therefore, the number of components of the vehicular door 1 can be easily reduced. No plate members are inside the vehicular door and the vehicular door has a large space therein. Therefore, functional components can be mounted in the space with a wide variety of arrangement. This simplifies a process of producing the vehicular door and a production cost is reduced.

The outer panel 20 may be made of metal and may be made of resin. The panel members of the inner panel 22 may not be made of resin but a portion of the panel members may be made of metal. For example, one of the first panel member and the second panel member may be made of metal and configured as a base member and the second panel member may be made of resin. The second panel member made of resin may be mounted on the first panel member, which is the base member, on the vehicular interior side.

The first panel member 24 includes a first panel body portion 30 including the non-overlapping portion and a hole 30A, a first front wall portion 31 that extends from a front edge of the first panel body portion 30 toward a vehicular exterior side, and a rear wall portion 32 that extends from a rear edge of the first panel body portion 30 toward the vehicular exterior side. The second panel member 25 is mounted on the first panel member 24 on the vehicular interior side with respect to the first panel member 24 to cover the hole 30A of the first panel body portion 30.

The first panel member 24 may be configured as the base member of the inner panel 22. Many of the components of the vehicular door except for the outer panel 20 can be attached to the first panel member 24. For example, the second panel member 25 may be mounted on the first panel member 24 on the vehicular interior side and functional components may be attached to the first panel member 24 on the vehicular interior side and the vehicular exterior side. With the vehicular door having such a configuration, rigidity of the inner panel and rigidity of the vehicular door can be ensured and mounting operations can be performed easily.

The second panel member 25 covers a lower section of the first panel body portion 30 to have a space between the interior side surface of the first panel body portion 30 and the second panel member 25, and the space opens upward.

With the vehicular door having a such a configuration, small items can be put in the space from the vehicular interior side. According to such a vehicular door, a door pocket 11 is configured by two panel members 24, 25. Therefore, any additional component is not necessary for forming the door pocket 11 and cost increase can be suppressed.

The vehicular door further includes the reinforcing members 62, 63, 64 disposed on the vehicular exterior side with respect to the inner panel 22 and extending in a vehicular front-rear direction from the first front wall portion 31 to the rear wall portion 32.

The reinforcing members 62, 63, 64 increase strength of the vehicular door. With the reinforcing member 64 being disposed in a middle section of the inner panel 22 with respect to the upper-bottom direction, the reinforcing member 64 may be configured as an impact beam for reducing shock from the outside of the vehicle.

The first panel member 24 is made of aluminum alloy with diecasting. Unlike the known vehicular door, when producing the vehicular door having such a configuration, the operation of welding multiple metal members is not necessary. This simplifies the production process of the vehicular door and increase of production cost is suppressed. Compared to a vehicular door made of resin, the vehicular door having the above configuration can easily have rigidity and a brand-new vehicular door including an interior part made of metal is obtained.

The inner panel 22 is fixed to a vehicle body BD via the hinge mechanism 19 such that the vehicular door is opened and closed with moving around the hinge mechanism 19, and the outer panel 20 is mounted on the inner panel 22 so as to be detachable from the inner panel 22 with the inner panel 22 being fixed to the vehicle body BD.

In the above configuration, the outer panel 20 is detachably mounted on the inner panel 22 as follows. After hooking the upper edge of the outer panel 20 on the inner panel 22, the side portions and the lower edge of the outer panel 20 may be fitted to the inner panel 22. Furthermore, by sliding the outer panel 20 laterally with respect to the inner panel 22, the outer panel 20 is detachably mounted on the inner panel 22. With the vehicular door having such a configuration, if there is a large scratch or a dent on the outer surface of the outer panel 20, for example, only the outer panel 20 can be easily detached from the inner panel 22 and replaced with a new one without replacing the inner panel 22 that includes most of the components of the vehicular door. Therefore, the repairing operation is simplified and cost increase is suppressed.

### OTHER EMBODIMENTS

The technology described herein is not limited to the embodiment described above with reference to the drawings. The technology described herein may be modified within the technical scope. The following embodiments may be included in the technical scope.

The inner panel 22 may include two, four or more panel members that include the non-overlapping portions.

In the above embodiment, the first panel member 24 of the inner panel 22 includes the first front wall portion 31 and the rear wall portion 32 and is configured as the base member of the inner panel 22. However, a panel member including a front wall portion and a panel member including a rear wall portion may be joined together and configured as a base member of an inner panel.

In the above embodiment, the outer panel 20 is detachably mounted on the inner panel 22. However, an outer panel may be mounted on an inner panel by sliding the outer panel laterally with respect to the inner panel. With such a configuration, when separating the outer panel from the inner panel, the outer panel is moved with sliding in a direction (rearward) to be away from a hinge mechanism and pulling the outer panel from an opposite side (the rear side) from the hinge mechanism of the inner panel. Thus, the outer panel can be separated from the inner panel. On the other hand, the outer panel and the inner panel are joined together by sliding the outer panel 20 in a direction (frontward) to be closer to the hinge mechanism from the opposite side (the rear side) from the hinge mechanism and overlapping the outer panel and the inner panel.

The present technology is not necessarily applied to an automobile but may be applied to various kinds of vehicles including vehicles on ground such as a train and an amusement vehicle, aircrafts such as an airplane and a helicopter, and watercrafts such as a ship and underwater vehicles such as a submarine.

1. A vehicular door comprising:
an outer panel having an external side surface that is configured as an outer wall surface of a vehicle; and
an inner panel disposed on a vehicular interior side with respect to the outer panel and having an interior side surface that faces a compartment space of the vehicle, the inner panel including at least a first panel member and a second panel member, and
each of the first panel member and the second panel member including a non-overlapping portion that has the interior side surface facing the compartment space and an exterior side surface directly facing the outer panel without having any panels between the non-overlapping portion and the outer panel.

2. The vehicular door according to claim 1, wherein
the first panel member includes
a first panel body portion including the non-overlapping portion and a hole,
a front wall portion that extends from a front edge of the first panel body portion toward a vehicular exterior side, and
a rear wall portion that extends from a rear edge of the first panel body portion toward the vehicular exterior side, and
the second panel member is mounted on the first panel member on the vehicular interior side with respect to the first panel member to cover the hole of the first panel body portion.

3. The vehicular door according to claim 2, wherein the second panel member covers a lower section of the first panel body portion to have a space between the interior side surface of the first panel body portion and the second panel member, and the space opens upward.

4. The vehicular door according to claim 2, further comprising a reinforcing member disposed on the vehicular exterior side with respect to the inner panel and extending in a vehicular front-rear direction from the front wall portion to the rear wall portion.

5. The vehicular door according to claim 1, wherein the first panel member is made of aluminum alloy with diecasting.

6. The vehicular door according to claim 1, wherein
the inner panel is fixed to a vehicle body via a hinge such that the vehicular door is opened and closed with moving around the hinge, and
the outer panel is mounted on the inner panel so as to be detachable from the inner panel with the inner panel being fixed to the vehicle body.

7. The vehicular door according to claim 1, wherein
the first panel member includes a first panel body portion including the non-overlapping portion and a hole, and
the second panel member is mounted on the first panel member on a vehicular interior side with respect to the first panel member to cover the hole of the first panel body portion and the overlapping portion of the second panel member is opposite the outer panel via the hole of the first panel body portion.

8. The vehicular door according to claim 2, wherein an upper edge portion of the first panel member above the hole is configured as the overlapping portion.
